(19) United States
(12) Patent Application Publication
(10) Pub. No.: US 2021/0303723 A1
(43) Pub. Date: Sep. 30, 2021

(54) SECURE HETEROGENOUS COMPUTING PLATFORM

(71) Applicant: SRC Labs, LLC, Dallas, TX (US)

(72) Inventors: Todd Rooke, Colorado Springs, CO (US); Jon Huppenthal, Colorado Springs, CO (US); Timothy P. Wilkinson, Apalachin, NY (US)

(21) Appl. No.: 17/218,132

(22) Filed: Mar. 30, 2021

Related U.S. Application Data
(60) Provisional application No. 63/002,482, filed on Mar. 31, 2020.

(51) Int. Cl. G06F 21/62; G06F 21/57; G06F 21/76; G06F 9/455

(52) U.S. Cl. CPC G06F 21/6236; G06F 21/577; G06F 2221/034; G06F 9/45512; G06F 21/76

(57) ABSTRACT

According to various embodiments disclosed herein, methods and systems for managing security vulnerabilities of a heterogeneous computing platform utilizing a microprocessor are disclosed. Specifically, methods and systems for managing attack surfaces of an instruction set architecture co-processor in communication with an FPGA control module are disclosed.

### BACKGROUND

Computing platforms provide numerous approaches to resist security breach and cyber-attacks, which can compromise the security of data records in highly sensitive data protection areas such as government organizations, social media, retail businesses, academic establishments and the like. Some of the common approaches used by security service developers include strict biometric access policies, enhanced firewall restrictions, data packet level inspection techniques and the like. However, these types of approaches do not provide effective mitigation of vulnerabilities in computing platforms utilizing heterogeneous computing, particularly with an instruction set architecture such as the commonly known x86 architecture associated with the 8086 microprocessor sold by Intel Corporation of Santa Clara, Calif. For example, platforms utilizing the x86 architecture present the potential for modification of an operating system used by the platform to cause a microprocessor to perform undesired functions.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to various embodiments disclosed herein, methods and systems for managing security vulnerabilities of a heterogeneous computing platform utilizing a microprocessor are disclosed. Specifically, methods and systems for managing attack surfaces of an instruction set architecture co-processor in communication with an FPGA control module are disclosed.

### BRIEF DESCRIPTION OF THE DRAWINGS

FIG. 1 is a block diagram of a secure heterogeneous computing platform;

FIG. 2 is a block diagram of an x86 co-processing system;

FIG. 3 is a block diagram of an x86 baseboard;

FIG. 4 is a block diagram of an FPGA application development platform; and

FIG. 5 is a flow diagram of a method for managing security vulnerabilities of an FPGA application.

### DESCRIPTION OF THE PREFERRED EMBODIMENTS

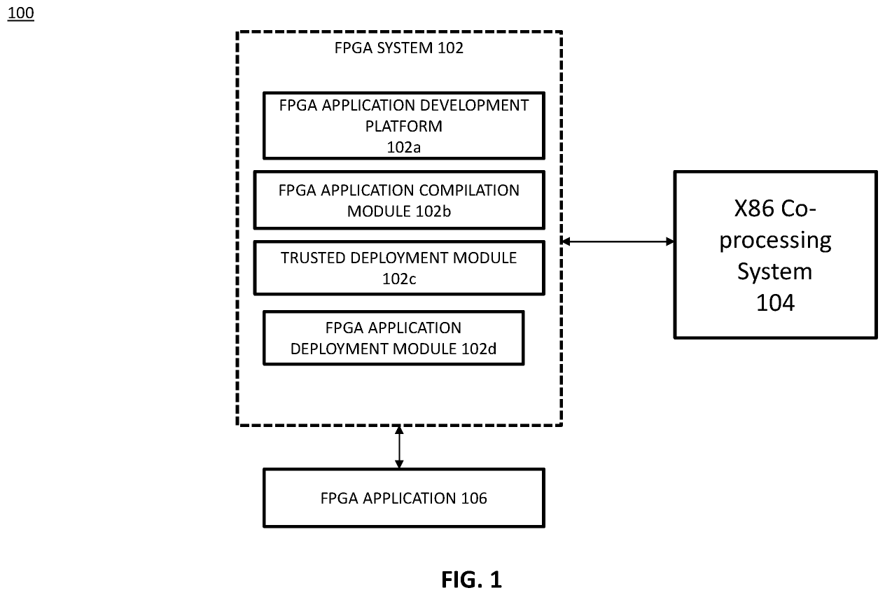

FIG. 1 is a schematic diagram of an FPGA system 102 and an instruction set architecture (herein x86) co-processing system 104 in a heterogeneous computing platform environment 100. The FPGA system 102 may be configured to support the development, deployment, execution, and maintenance of an FPGA application 106. The FPGA system 102 may comprise a set of APIs, libraries, tools, development environment, and other support components to be used for development and execution of the FPGA application 106. In some example embodiments, the FPGA application environment 100 may be an FPGA PaaS (Platform as a Service) environment, wherein the different modules of the FPGA system 102 may be accessed over a network. The FPGA system 102 may be used to build an FPGA application 106 configured for performing a plurality of computing functions.

In some example embodiments the FPGA application 106 can be configured to execute along with the x86 co-processing system 104 to providing enhanced security. The x86 co-processing system 104 is communicatively coupled to the FPGA system 102. In some example embodiments, the connection between the FPGA system 102 and the x86 co-processing system 104 may be direct. In some example embodiments the communication between the FPGA system 102 and the x86 co-processing system 104 may be performed over a network.

The FPGA system 102 comprises a set of modules. The modules include an FPGA application development platform 102a, an FPGA compilation module 102b, a trusted deployment module 102c, and an FPGA application deployment module 102d.

The FPGA application 106 may be built using a suitable application development module 102a that can include various tools used by a developer as will be discussed below. After assembling of source code using development module 102a, the FPGA application compilation module 102b can be used to compile the source code. The FPGA application 106 can be scaled for enterprise applications such that multiple FPGA compute nodes, multiple memory nodes, FPGA switches, and multiple I/O nodes coordinate together in an enterprise super compute platform, such as the FPGA application development platform 102a to provide improved security and performance as compared to current systems. In one embodiment, the entire FPGA application 106 executes computing, storage, switching, and networking without the use of an operating system.

In some example embodiments, when ready for deployment, the FPGA application compilation module 102b produces a multi-component application package, including one or more bitstreams and stream connection information specifying connection between streams within the FPGA application 106. The application package can be protected and encrypted in order to generate a secure deployment by the trusted deployment module 102c. The trusted deployment module 102c uses the application package to deploy the FPGA application 106 on one or more servers as specified within the FPGA application development platform module 102a. In one embodiment the trusted deployment module 102c can utilize one or more management FPGAs to communicate with and deploy the FPGA application 106. The one or more servers can be within a single data center or deployed across multiple data centers as desired.

The FPGA application compilation module 102b uses several elements such as a global stream manager, bitstream generator, place and route tools and monitoring and metering circuit generator. The global stream manager uses stream identifiers from source code files for the application and generates a namespace for each stream such that each stream has a unique identifier. As such, duplication of stream identifiers within the application is avoided. In some instances, FPGA application compilation module 102b generates a bitstream using bitstream generator for use with a specified FPGA or specific blocks in the FPGA application.

In instances where FPGA application 106 utilizes multiple compute nodes, an application package can be generated such that the application package identifies bitstreams for each compute node in the application. In this case, the FPGA application compilation module 102b receives source files as indicated by FPGA application development platform module 102a and uses the hardware version of libraries associated with bitstream generator of FPGA application compilation module 102b and invokes the FPGA place and route tools in order to generate one or more FPGA bitstreams. The bitstream(s) generated is included in an object file by the FPGA application compilation module 102b. The FPGA application compilation module 102b produces an application package, which can include one or more bitstreams (direct execution logic) for each of the compute nodes in the FPGA application 106.

The FPGA application compilation module 102b accepts source files and resource list files to provide an overview of the FPGA application to the developer. The source files can be from standard libraries, developed by third parties and/or internally developed. The FPGA application compilation module 102b can aggregate source files written in C and/or C++ and other low-level virtual machine (LLVM) supported languages as well as Verilog. As such, the developer can access low-level hardware capabilities: definition and creation of processor hardware from within high-level programming languages. This level of control over compute and memory access greatly facilitates achieving high computational performance. In one embodiment, the FPGA application compilation module 102b can import code written in different languages such as low level virtual machine (LLVM) languages, Intermediate Language (IL) in VB.NET and others (e.g., Java, C#, Swift). Upon import of this code, a developer can create composite data flow applications using a graphical user interface designating components visually or with a flow language. As such, a developer can optimize execution of an application with parallel or serially specific segments upon compilation of an FPGA application 106.

The trusted deployment module 102c, which accepts an application package from the FPGA application compilation module 102b. The trusted deployment module 102c uses a cryptography engine and deployment protocol manager. The cryptography engine encrypts the application package such that the encrypted file can be sent to a remote system for deployment. In combination, the deployment protocol manager can manage keys and other secure elements to ensure that the file encrypted by the cryptography engine remains secure and only deployed to a trusted destination. Ultimately, one or more encrypted bitstreams can be sent to remote systems for operation as desired. When multiple compute nodes are employed, the deployment protocol manager can govern what portions of the application are deployed to specified nodes used to operate the FPGA application 106

As used herein, an FPGA application includes any computer program that performs data processing where most or all of the data processing is performed on reconfigurable hardware such as an FPGA processor. In one embodiment, the run-time environment is entirely FPGA based without an operating system utilizing a mix of reconfigurable compute nodes, reconfigurable switches, reconfigurable common memory nodes, and reconfigurable I/O nodes. In another embodiment, in a run-time environment, the FPGA application can utilize a mix of microprocessors, such as the x86 co-processing system 104, with an operating system or compiled as machine code without an operating system, reconfigurable compute nodes, reconfigurable common memory accessible by the processors and switch modules in various combinations as specified. Other elements can be used in the FPGA application 106, such as stream protocols, stream data sources, I/O connectors (providing connection along an internal wire), I/O agents (providing connection to an external system, components of code blocks and composite components formed of multiple components of code blocks.

Within the FPGA application 106, the processors can operate independently or selectively as desired. In some embodiments, the FPGA application 106 includes one or more ingress points (portions of the FPGA application that receive input messages external to the FPGA application), one or more egress points (portions of the FPGA application that communicate output messages externally from the FPGA application), one or more reconfigurable compute nodes (e.g., physical FPGA's that process data), one or more memory nodes (e.g., persistent physical memory, non-persistent physical memory) accessible to the processing nodes whereby the processing nodes read and write data to the memory nodes and one or more switches including executable logic for routing and communicating among the processing and memory nodes. In some embodiments, the compute nodes can include microprocessors.

In some example embodiments, the FPGA application 106 in communication with the x86 co-processing system 104 may be used in a highly compute intensive enterprise application, such as marketplace or a social media application, to perform high speed information processing in real-time. The security vulnerabilities of the FPGA application 106 may be managed by the trusted deployment module 102c, along with encryption at source code level. Further, the FPGA application deployment module 102d may be used to safely deploy the FPGA application 106, such as on the hardware having a plurality of compute nodes. However, still the overall enterprise application may be prone to intrusion and cyber-attacks due to security vulnerabilities exposed at attack surfaces (e.g., software code) of an x86 co-processing system 104.

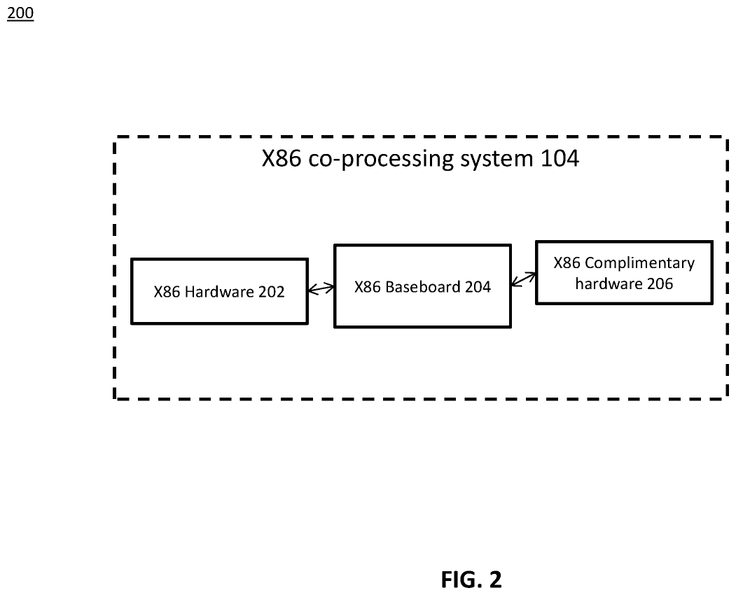

FIG. 2 is a block diagram 200 of an x86 co-processing system 104 in accordance with an exemplary embodiment of the present invention. The x-86 co-processing system 104 may include x86 hardware 202, an x86 baseboard 204 and x86 complimentary hardware 206. The x86 hardware 202 may be used for secure designing of the FPGA application 106. In an example, x86 hardware 202 may be configured in such a way to protect potential x86 attack surfaces and security vulnerabilities. x86 hardware 202 may comprise a secure design, which may be configured for identification and mitigation of x86 attack surfaces. When such a secure and robust x86 is used in co-processing configuration with an FPGA application, such as the FPGA application 106, the overall FPGA application also becomes secure.

In some example embodiments, the x86 baseboard 204 may include a durable baseboard based on the x86 processor that may be useful for designing a secure FPGA application. x86 baseboard 204 may provide for a plurality of functions in the x86 co-processing system 104. These functions may include but are not limited to intrusion detection and prevention, power management, fan management, temperature management and the like.

The x86 complimentary hardware 206 may include additional processing components, such as another microprocessor, an additional FPGA compute node, or an additional x86 processor. The x86 complimentary hardware 206 may be used for further increasing the computing capabilities of the overall system, while at the same time maintaining security of the x86 attack surfaces.

In some example embodiments, the x86 co-processing system 104 may be configured to leverage hardware defined network (HDN) packet inspection and filtering to provide secure x86 computing. In some example embodiments, x86 co-processing system 104 may be configured to accelerate or mitigate the security terms generated during testing.

In some example embodiments, the x86 co-processing system 104 may be remotely managed. For example, the x86 co-processing system 104 may be configured to operate as a Kernel Virtual Machine (KVM). This may be done to allow virtualization to be used in the implementation of the FPGA application 106. KVM provided reliability and ability to manage heavy workloads for any system using KVM technology. The KVM technology may be used by the FPGA application development platform module 102a discussed earlier for providing long term operational support for the FPGA application 106.

In some example embodiments, the x86 co-processing system 104 and the FPGA application 106 may be made secure by writing an immutable hash graph for every platform access transaction directed towards the FPGA application development platform access module 102a, which in turn leads to controlling access to the x86 co-processing system 104, which in turn would lead to managing of the x86 attack surfaces. The immutable hash graph may comprise using a networking protocol, such as the gossip protocol, to keep a record of all the events and access attempts made for accessing the FPGA system 102. The FPGA system 102 may in turn be configured to manage access to the x86 co-processing system 104. The access to the x86-co-processing system may be managed through one or more communication ports available for the x-86 co-processing system 104, and specifically the access ports available at the x86 baseboard 204.

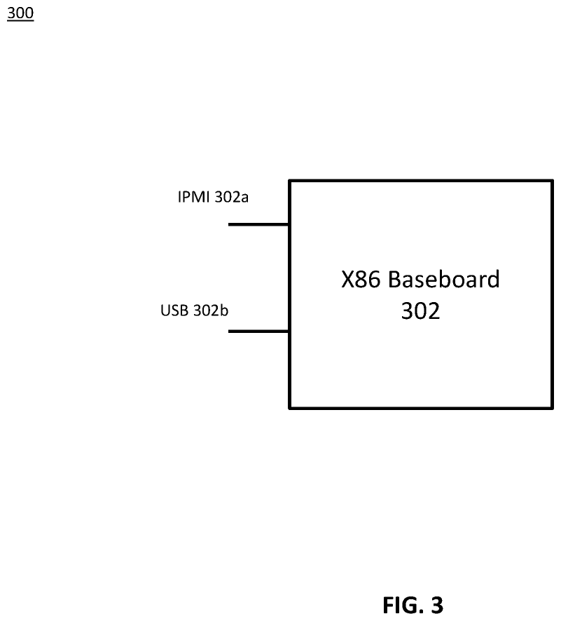

FIG. 3 illustrates the access ports available for accessing the x86 co-processing system 104 through an x86 baseboard 302. As illustrated in FIG. 3, the x86 baseboard 302 may comprise an Intelligent Platform Management Interface (IPMI) port 302a and a Universal Serial Bus (USB) port 302b for accessing the x86 baseboard 302. Access to either of the ports 302a or 302b can result in generation of a hash graph discussed above. In some example embodiments, the immutable hash graph can be generated and managed by the FPGA system 102 which may be configured for managing access to the x86 baseboard, and its associated firmware, through either of the two ports, the IPMI port 302a or the USB port 302b.

In some example embodiments, access to the x86 baseboard 302 can be managed by the FPGA system 102 by providing a proxy first in first out (fifo) interface for accessing either of the ports 302a or 302b. The traffic can be contained and checked for attacks at this proxy fifo interface to prevent attack at the x86 system 104. In some example embodiments, using the proxy fifo interface may make the x86 co-processing system 104 securely contained in a secure execution environment, under the control of a secure FPGA application 106. This may further assist in accelerating the application migration with hybrid executables. Such secure application environment may provide effective x86 attack surfaces management, thereby providing greater security to x86 co-processing system 104.

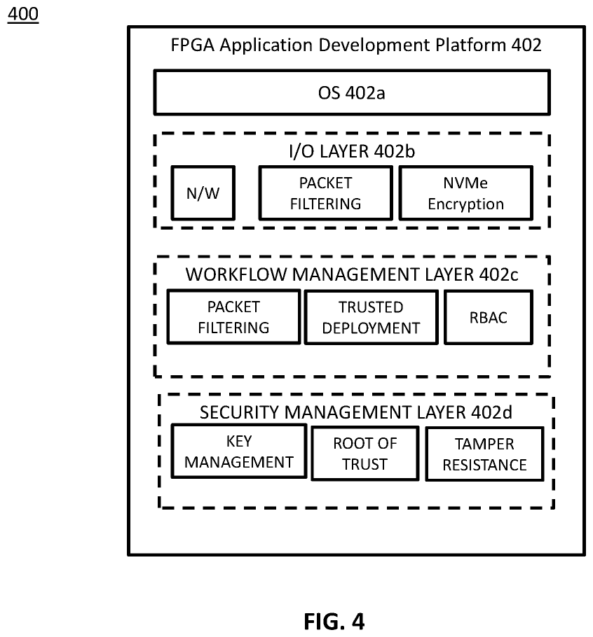

In some example embodiments, the control code and control processing for providing security features discussed above may be managed and provided by the FPGA application development platform 102a discussed earlier in conjunction with FIG. 1 and further elaborated in the description of FIG. 4 as follows.

FIG. 4 illustrates an exemplary block diagram of the FPGA application development platform 402. The FPGA application development platform 402 may include an operating system module OS 402a, an I/O layer 402b, a workflow management layer 402c, and a security management layer.

In some example embodiments, the OS 402a may be external to the FPGA application development platform 402. The OS may be any of the well know operating systems available in the art such as Microsoft Windows, Linux, Apple OS, Android and the like.

The I/O layer 402b may further comprise a plurality components such as a networking component N/W, a packet filtering component and an NVMe (non-volatile memory express) encryption component. The I/O layer 402b may be configured for sending and/or receiving data to and from the FPGA application development platform. In some example embodiments, the N/W component of the I/O layer 402b may comprise an ingress module for receiving network traffic and an egress module for sending out traffic to the network. In some example embodiments, all requests received at the ingress module may be in accordance with secure network policies so that possible sources of attack are not able to disrupt the operation of the FPGA application 106 supported by the FPGA application development platform 402. The I/O layer 402b also comprises the NVMe encryption component that may provide a secure interface for non-volatile memory access using the peripheral component interface (PCI) standard. In some embodiments, the data exchange between the x86 co-processing system 104 and the FPGA application development platform 402 (and thus the FPGA system 102) may happen over a SATA connection to access the NVMe encryption component. In some embodiments, the data exchange between the x86 co-processing system 104 and the FPGA application development platform 402 (and thus the FPGA system 102) may happen over a PCIe connection to access the NVMe encryption component.

In some example embodiments, the x86 co-processing system 104 may have USB and VGA ports which may be accessed securely using the I/O layer 402b of the FPGA application development platform 402. Thus, the x86 USB and VGA ports may not be unnecessarily exposed, leading to reduction in possible attacks being directed to the x86 co-processing system 104. Further, in some embodiments, a direct path may be established to terminate a VGA signal from the x86 co-processing system 104 and mux it or encode it and then transmit it as a movie stream to the I/O layer 402b.

The I/O layer 402b may also include the packet filtering module to filter all the data, traffic, and information entering into the FPGA application 106 and to the x86 co-processing system 104 through the FPGA application development platform 402. The packet filtering module may help to filter out any spurious or malicious data, thus providing a level of security which may help to mitigate vulnerabilities at the x86 attack surfaces. The I/O layer may be in communication with the workflow management layer 402c which may help to manage the working of the FPGA development platform by containing control and processing code.

The workflow management layer 402c may also provide additional security layer for mitigating security vulnerabilities of the FPGA application 106 and the x86 attack surfaces (such as of the x86 co-processing system 104). The workflow management layer 402c may include a packet filtering module, a trusted deployment module and a role based access control (RBAC) module for providing an additional level of security to the control and processing operations of the FPGA application development platform 402. The packet filtering module of the workflow management layer 402c may filter spurious data and traffic. The trusted deployment module of the workflow management layer 402c may be similar in operation to the trusted deployment 102c of the FPGA system 102 discussed earlier in conjunction with FIG. 1 and may assist in securely deploying the FPGA application 106. The trusted deployment module 102c may be configured to implement a plurality of policies comprising a plurality of security checks on the control code of the FPGA application to ensure safe deployment of the FPGA application 106. The workflow management layer 402c may also comprise the RBAC module for controlling access of the FPGA application 106 and the x86 co-processing system 104 only by authorized users. In some example embodiments, the RBAC module may assist in restricting access to sensitive information, such as the x86 interface surface and the FPGA control code only to authorized users. Users may be divided into different roles, such as an employee, an administrator, a customer, a developer and the like. Access rights for sensitive information may be selectively configured for different categories of users and thus potential attacks and security breaches may be avoided. The RBAC module along with other modules within the workflow management layer 402c may provide additional security to the FPGA application development platform 402.

The FPGA application development platform 402 may also include a dedicated security management layer 402d for managing the security of the FPGA application development 402. The security layer 402d may comprise a key management module, a root of trust module, and a tamper resistance module. The security management layer 402d may be configured to perform encryption of code blocks within the FPGA application 106. The encryption and decryption of data, such as the control code, may be done on the basis of security keys managed by the key management module. Further the root of trust module may be configured to implement a set of functions associated with the trusted deployment module of the FPGA application development platform 402 to enable cryptographic processing. The root of trust module may comprise a dedicated hardware for securely maintaining keys and other cryptography related data, such as digital signatures, that may be provided for encrypting and decrypting data and information exchanged with the FPGA application development platform 402. Further, the tamper resistance module may comprise a tamper resistant chassis within which a system comprising the hardware associated with the FPGA application development platform 402, such as the FPGA system 102, may be disposed. The tamper resistance module may enable prevention of tamper or destruction efforts to the FPGA system 102 and the x86 co-processing system 104 by malicious users.

In some example embodiments, the security management layer 402d, along with the I/O layer 402b and the workflow management layer 402c may represent a containerized stack of layers for an FPGA application development platform 402 that may be used for development of an FPGA application, such as the FPGA application 106. It may be noted that the layers depicted in FIG. 4 are for one particular embodiment of the FPGA application development platform 402 showing only three layers. However, there may be fewer or more layers of the FPGA application development platform 402 as may be required, which is well within the scope of this invention.

In some example embodiments, the FPGA application development platform 402 may be configured to provide various functionalities for the FPGA application 106 development. These services may include but are not limited to providing support for various artifacts such as Git, HTTP, Raw etc; step-level inout and output; loops; parameterization; conditional statements; timeouts; resource orchestration; garbage collection; scheduling and the like. The services may be used in the development of the FPGA application 106.

In one embodiment, the FPGA application 106 may be programmed to perform networking functions, and directly receives network packets (e.g., Ethernet packets) as input messages via the I/O layer 402b, and a set of FPGA compute nodes may implement a business application including business rules in hardware. In one form of this embodiment, the entire business application stack may be implemented within reconfigurable compute nodes, from the communications (e.g., Ethernet) layer up to the business application of the FPGA application 106, including the I/O layer 402b and FPGA compute nodes. That is to say, excluding translation from an incoming message to a format readable by configurable processor and translation from the format readable by the reconfigurable processor to an outgoing message format, the reconfigurable processors perform all processing within the FPGA application 106 without an operating system managing resources. In one specific embodiment, the compute nodes form the primary computing function for the FPGA application 106 without the use of an operating system managing the reconfigurable processor or any other hardware resources of the FPGA application 106. That is to say that the FPGA application 106 operates independent from any operating system. In another embodiment, the networking functions and business application may include separate processing elements deployed in any manner across multiple reconfigurable compute nodes and multiple cards. In one embodiment, the I/O layer 402b acts as a translator of network packets to binary information in order for the set of FPGA compute nodes to process the binary information. Communication among the FPGA compute nodes can be governed by a communication protocol (e.g., also using binary information) as discussed below.

In some example embodiments the FPGA application 106, may be configured to provide a high availability solution for an enterprise. For example, the FPGA compute nodes may perform redundant work so that if one or more of the FPGA compute nodes fail, the FPGA application 106 is still able to provide an answer or response to messages sent to the FPGA application 106. In one implementation, the I/O layer 402b according to one embodiment will simultaneously provide input streams to multiple FPGA compute nodes, and some or all of the FPGA compute nodes will perform identical computing on the received input streams. Each of these FPGA compute nodes will then provide an output stream to the I/O layer 402b. The I/O layer 402b receives the output streams and identifies a single one of the output streams (e.g., using a consensus algorithm) to provide as output message. In some example embodiments, the I/O layer 402b may provide an immutable hashgraph representing output streams and thus, the FPGA application 106 provides high availability and increased reliability of responses.

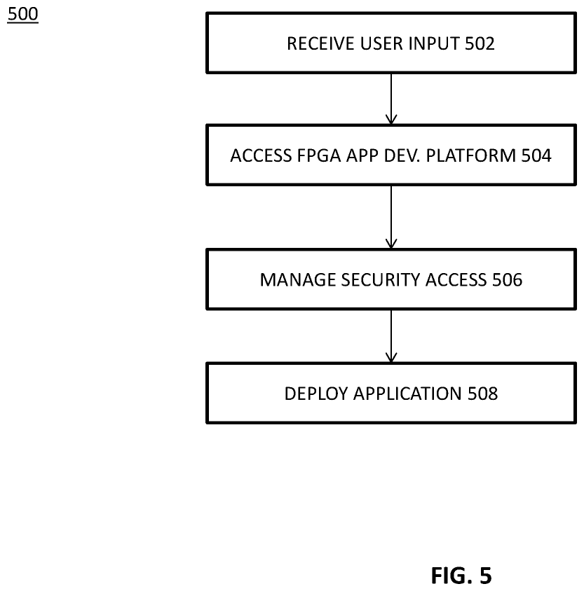

FIG. 5 is a flow diagram of a method 500 for managing security vulnerabilities of an FPGA application. The method 500 may include, at 502, receiving a user input such as from one or more I/O ports of the FPGA system 102. In some embodiments, the user input may comprise an input stream of data directed to the I/O layer 402a of the FPGA application development platform 402.

The method 500 may further include, at 504, accessing the FPGA application development platform, such as the FPGA application development platform module 102a or the FPGA application development platform 402 for accessing security functions of the FPGA application. In some example embodiments, the FPGA application development platform module 102a may provide APIs for accessing the security functions on the FPGA system 102.

The method may further include, at 506, managing security access, such as managing access to one or more x86 co-processing systems attack surfaces using one or more security policies. For example, one of the policies may include implementing an immutable hashgraph for directing all access transactions to x86 co-processing system 104 using the FPGA system's secure operational checks.

Once the security checks have been managed, the method 500 may include, at 508, deploying the FPGA application 106, and using the x86 co-processing system 104.

It may be understood that the method 500 illustrates only an exemplary combination of steps. The method may further include one or more additional combinations of steps with more or fewer functionality than the steps illustrated in FIG. 5. The method 500 may be used to enhance the security of the FPGA system 102 so as to be able to mitigate the security vulnerabilities of the FPGA system 102 and the x86 attack surfaces.

In one embodiment the FPGA system 102 may be used to generate FPGA application based network interface for an operating system, such as Linux, Android and the like.

In one embodiment, the FPGA system 102 may be configured to encrypt and/or decrypt all the inbound traffic, commands and events directed to the FPGA system 102.

In one embodiment, the FPGA system 102 may be configured to provide FPGA based storage management for an underlying operating system, such as Linux, Android and the like.

Although the present invention has been described with reference to preferred embodiments, those skilled in the art will recognize that changes can be made in form and detail without departing from the spirit and scope of the present invention. The various embodiments of the invention have been described above for purposes of illustrating the details thereof and to enable one of ordinary skill in the art to make and use the invention. The details and features of the disclosed embodiment are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A computer implemented method, comprising:
receiving, by a processor, an input data stream;
accessing, by the processor, an FPGA system;
managing security access configurations of the input data stream by the FPGA system to provide a secure input data stream to an instruction set architecture system.

2. The computer implemented method of claim 1, further comprising recording access to the instruction set architecture system with a hashgraph.

3. The computer implemented method of claim 1, wherein control of the instruction set architecture system is provided using a command line interface of the FPGA system.

4. The computer implemented method of claim 1 wherein the instruction set architecture system is an x86 architecture.

5. The computer implemented method of claim 1 wherein FPGA system and the instruction set architecture system are configured to cooperatively execute an FPGA application.
